(19) United States
(12) Patent Application Publication
(10) Pub. No.: US 2012/0042244 A1
(43) Pub. Date: Feb. 16, 2012

(54) Software application for the method of creating, engaging in and completing (or failing to complete) allowances on pre-programmed activities or newly created activities

(76) Inventor: Conrad Ross Schulman, New York, NY (US)

(21) Appl. No.: 12/806,398

(22) Filed: Aug. 11, 2010

(51) Int. Cl. G06F 3/00

(52) U.S. Cl. 715/700

(57) ABSTRACT

The software application for creating, engaging in and completing (or failing to complete) allowances on pre-programmed activities or newly created activities are disclosed. A user creates an allowance for a selected activity and inputs allowance details (i.e. time period from “start date” to “end date,” specific number of uses, per week/month/year.) The user then engages in the selected activity in real life and tracks the engagement of the activity online. Tracking engagement in the activity will cause the user's displayed allowance to adjust according to the number of engagements. At the end of the time period of the allowance (i.e. “end date”), the user's allowance will display the number of uses the user actually engaged in alongside the original number of uses specified in the first step of the allowance creation. The user may create, engage in and complete (or fail to complete) in numerous allowances, and repeat the process.

The invention is software application for the method of creating, engaging in and completing (or failing to complete) allowances on pre-programmed activities or newly created activities.

The first step of the software application is the creation of an allowance. The user checks off a pre-programmed activity (i.e. “Golf”) or creates a new activity (i.e. “Breaking my cell phone”). The user then inputs the time period for the allowance by typing in a “start date” and “end date.” The user inputs a specific number of uses for the activity, either per week or per month or per year.

The second step of the software application is the fulfillment of the selected activity. The user tracks the engagement in the activity (set in the allowance in the first step). The user's displayed allowance will adjust itself according to the number put in by the user (this is referred to as “tracking”)

The third step of the software application is the completion (or failure to complete) of the allowance. At the “end date” of the time period of the allowance, the user's allowance will be displayed to the user. The left hand side will display the number of engagements in the activity as input by the user. Separated with a slash or “/”, the right hand side will display the specific number of uses that was originally set by the user in the allowance creation process. The user can repeat the allowance process endless times and the user can access previously completed and failed allowances.

### BACKGROUND OF THE INVENTION

### Field of Invention

The present invention relates to the software application for the method of creating, engaging in and completing (or failure to complete) an allowance on a pre-programmed activity or a newly created activity.

Traditionally, allowances on pre-programmed activities or newly created activities are not realized because the creation, engagement in and completion of an allowance are impossible to do without a software application. Without software application, the allowance data accumulates, without the help of a server to store and display the user's data.

### BRIEF SUMMARY OF THE INVENTION

The summary of the invention is a new software application that manages allowances on pre-programmed or newly created behavioral activities. This software application gives the user the ability to create, engage in and complete (or fail to complete) allowances on pre-programmed or newly created behavioral activities, as well as the ability to store and display previously completed and failed allowances.

Prior to this software application, a user would attempt to manage an allowance through more fallible methods like memory or simple “ink and paper.” Both methods are inefficient due to the lack of a server to store all the recorded data gained from the user. The user's personal memory is unable to record and access a large multitude of numbers, while the “ink and paper” will inevitably fail due to the large and constant influx of data and lack of a server organizational tool.

### BRIEF DESCRIPTION OF THE SEVERAL VIEWS OF THE DRAWINGS

FIG 1a is a screen shot of a user checking off a pre-programmed activity.

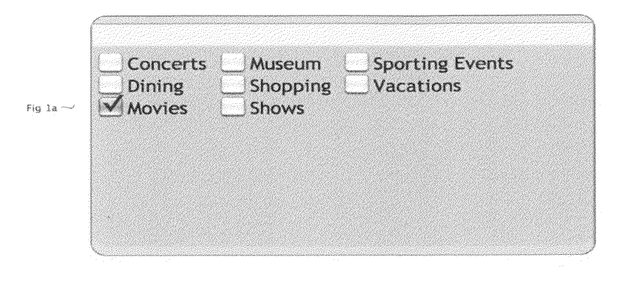

FIG. 2a is a screen shot of a user creating a new activity.

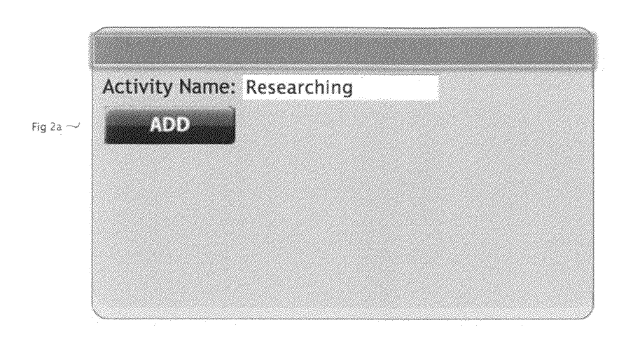

FIG. 3a is a screen shot of a user selecting an activity for the allowance.

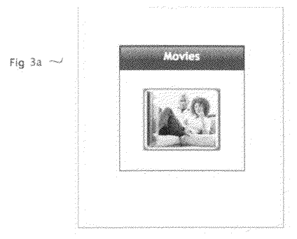

FIG. 3b is a screen shot of a user selecting the time period.

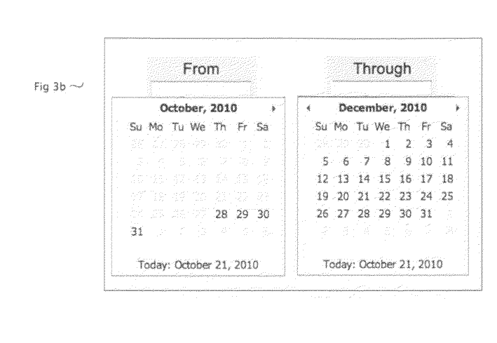

FIG. 3c is a screen shot of a user inputting the specific number of uses.

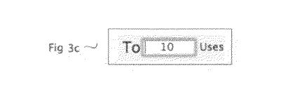

FIG. 3d is a screen shot of a user selecting per week or per month or per year.

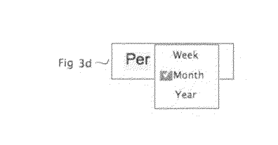

FIG. 3e is a screen shot of a user setting an allowance.

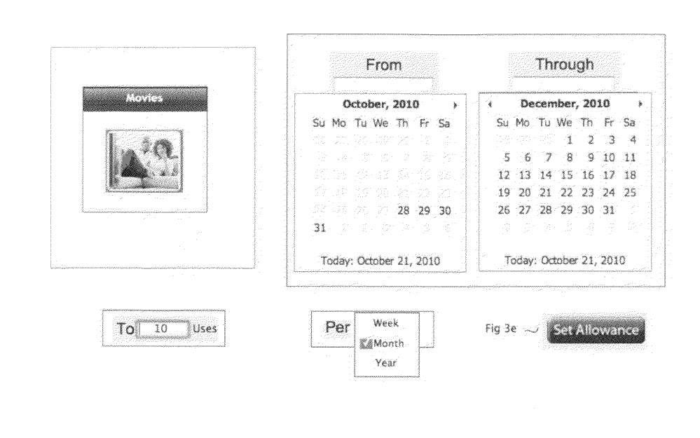

FIG. 4a is a screen shot of a user engaging in an allowance.

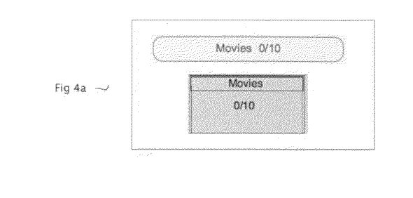

FIG. 5a is a screen shot of a user tracking the engagement in the activity.

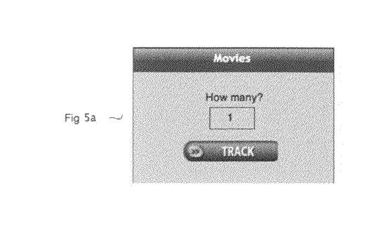

FIG. 6a is a screen shot of a users allowance changing according to the number of engagements tracked.

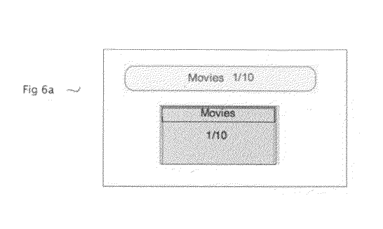

FIG. 7a is a screen shot of a users allowance displayed at the end of the time period set for the allowance, either a completed or failed allowance.

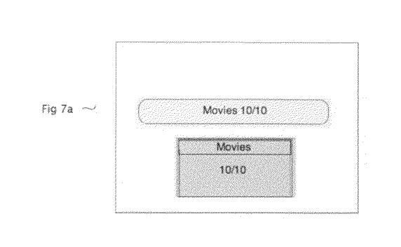

FIG. 7b is a screen shot of a user accessing previous allowances through the drop-down menu on the left.

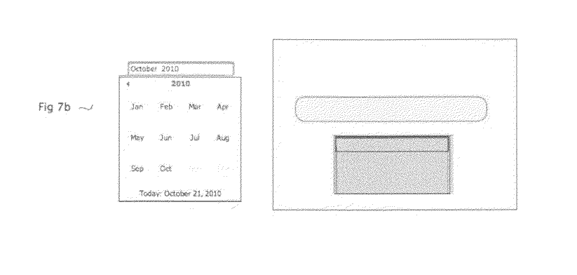

### DETAILED DESCRIPTION OF THE INVENTION

The invention is software application for the method of creating, engaging in and completing (or failing to complete) allowances on pre-programmed activities or newly created activities.

The first step of the software application is the creation' of an allowance. The user checks off a pre-programmed activity (i.e. “Golf”) or creates a new activity (i.e. “Breaking my cell phone”). The user then inputs the time period for the allowance by typing in a “start date” and “end date.” The user inputs a specific number of uses for the activity, either per week or per month or per year.

The second step of the software application is the fulfillment of the selected activity. The user tracks the engagement in the activity (set in the allowance in the first step). The user's displayed allowance will adjust itself according to the number put in by the user (this is referred to as “tracking”).

The third step of the software application is the completion (or failure to complete) of the allowance. At the “end date” of the time period of the allowance, the user's allowance will be displayed to the user. The left hand side will display the number of engagements in the activity as input by the user. Separated with a slash or “/”, the right hand side will display the specific number of uses that was originally set by the user in the allowance creation process. The user can repeat the allowance process endless times and the user can access previously completed and failed allowances.

The present invention's purpose is for its user to execute allowances on a behavioral activity that he/she engages in.

The present invention must not be confused with prior inventions such as “spending allowances” or “weight management mechanisms”. The invention “Method and system for network-based allowance control” is an example of an invention that falls under the “spending allowance” category. The inventions “compliance support package for increasing health management system,” “personal nutrition control method and measuring devices,” and “weight control method using physical activity based parameters” all fall under the “weight management mechanisms” category.

1. I claim the software application for the method of creating, engaging in and completing (or failing to complete) allowances on pre-programmed activities or newly created activities.
